(19) United States
(12) Patent Application Publication
(10) Pub. No.: US 2015/0020625 A1
(43) Pub. Date: Jan. 22, 2015

(54) SEED METERING DEVICE DRIVE SYSTEM FOR A TWIN-ROW SEEDER

(71) Applicant: Actuant Corporation, Menomonee Falls, WI (US)

(72) Inventors: Kevin Hause, Binghamton, NY (US); Kevin Shaw, Binghamton, NY (US)

(73) Assignee: Actuant Corporation, Menomonee Falls, WI (US)

(21) Appl. No.: 14/377,660

(22) PCT Filed: Feb. 1, 2013
(86) PCT No.: PCT/US2013/024261

§ 371 Date: Aug. 8, 2014

Related U.S. Application Data
(60) Provisional application No. 61/597,467, filed on Feb. 10, 2012.

(51) Int. Cl. A01C 19/02; F16H 35/00; F16H 1/20

(52) U.S. Cl. CPC A01C 19/02; F16H 1/20; F16H 35/00
USPC 74/405

(57) ABSTRACT

An apparatus is disclosed for transmitting power from a drive shaft to a seed meter shaft of a seed metering device. The apparatus includes a transmission having a transmission housing and an input rotatably supported by the transmission housing. The input engages a coupling driven by the drive shaft such that the coupling drivingly engages the input. The transmission further includes an output rotatably supported by the transmission housing. The output is driven by the input and configured to drive the seed meter shaft. The transmission further includes an adjustment element rotatably supported by the housing and connected to the input. The adjustment element is manually rotatable to rotate the input and the output and thereby adjust an angular position of the seed meter shaft relative to the drive shaft.

### TECHNICAL FIELD

This invention relates to power trains for seeders, particularly seeder power trains for twin row seeders.

### BACKGROUND ART

Agricultural seeding implements, such as row crop planting implements and the like, typically include multiple seed metering devices that separate seeds from one another such that individual seeds can be dispensed at consistent intervals. Such seed metering devices can take various forms. For example, some seed metering devices use a vacuum to direct seeds, while others employ seed-selecting “fingers”. Regardless of their specific construction, all the seed metering devices on a planting implement are typically driven by a common drive shaft. Moreover, each seed metering device connects to a separate drive system that transmits power from the common drive shaft to the seed metering device.

To increase soil usage and provide additional space for plant roots, some seeding implements distribute seeds in a manner in which the seeds between pairs of closely-spaced rows are offset or staggered from each other. That is, each seed's nearest adjacent seeds are located in the adjacent row, which generally provides an overall “zig-zag” pattern. In order to distribute seeds in this manner, so called “twin-row” seeding implements include multiple pairs of offset seed metering devices (e.g., one seeder in each pair has a length of 30 inches and the other has a length of 15 inches) that drop seeds, e.g., 180 degrees out of phase from each other.

The offset between seeds is sometimes adjusted, e.g., to provide different spacing for different types of seeds. Unfortunately, twin-row seeding implements are difficult and tedious to adjust in such situations. Typically, an operator disconnects at least one of the seed metering devices in each pair from the drive shaft (which typically involves removing a chain from a sprocket), adjusts the angular position of the seed metering device, and reconnects the seed metering device to the drive shaft. Such a task can be particularly painstaking and time-consuming for seeding implements that include several dozen pairs of seed metering devices.

Considering the above drawbacks, what is needed in the art is an easily adjusted seed metering device for twin-row seeding implements.

### DISCLOSURE OF INVENTION

In one aspect, the present invention provides an apparatus for transmitting power from a drive shaft to a seed meter shaft of a seed metering device. The apparatus comprises a transmission including a transmission housing and an input rotatably supported by the transmission housing. The input has a first side configured to engage a coupling driven by the drive shaft such that the coupling drivingly engages the input, and the input also has a second side opposite the first side. The transmission further includes an output rotatably supported by the transmission housing. The output is driven by the input and configured to drive the seed meter shaft. The transmission further includes an adjustment element rotatably supported by the housing and connected to the second side of the input. The adjustment element is manually rotatable to rotate the input and the output and thereby adjust an angular position of the seed meter shaft relative to the drive shaft.

In another aspect, the present invention provides an apparatus for transmitting power from a drive shaft to a seed meter shaft of a seed metering device. The apparatus comprises a clutch assembly driven by the drive shaft, and the clutch assembly transmits power from an input to an output if the input is driven in a first direction and rotatably disconnects the input and the output if the input is driven in a second direction. The apparatus further comprises a coupling driven by the clutch assembly and a transmission. The transmission includes a transmission housing and an input gear rotatably supported by the transmission housing and driven by the coupling. An output gear is rotatably supported by the transmission housing and driven by the input gear, and the output gear is configured to drive the seed meter shaft. An adjustment element is rotatably supported by the housing and connected to the input gear. The adjustment element is manually rotatable only in the first direction to rotate the input gear and the output gear to thereby adjust an angular position of the seed meter shaft relative to the drive shaft as the clutch assembly rotatably disconnects the input and the output.

The foregoing and other aspects of the invention will appear in the detailed description which follows. In the description, reference is made to the accompanying drawings which illustrate a preferred embodiment of the invention.

### BRIEF DESCRIPTION OF DRAWINGS

The invention will hereafter be described with reference to the accompanying drawings, wherein like reference numerals denote like elements, and:

FIG. 1 is an exploded perspective view of a seed metering device drive system according to the present invention;

FIG. 2 is a perspective view of a clutch assembly of the seed metering device drive system of FIG. 1;

FIG. 3 is a front view of the clutch assembly of FIG. 2;

FIG. 4 is a rear view of the clutch assembly of FIG. 2;

FIG. 5 is a section view of the clutch assembly along line 5-5 of FIG. 2;

FIG. 6 is a section view of a flexible shaft of the seed metering device drive system along line 6-6 of FIG. 1;

FIG. 7 is a side view of a seed meter transmission of the seed metering device drive system of FIG. 1;

FIG. 8 is a detail view of the seed meter transmission within line 8-8 of FIG. 7;

FIG. 9 is a section view of the seed meter transmission along line 9-9 of FIG. 1; and

FIG. 10 is an exploded perspective view of a second embodiment of a seed metering device drive system according to the present invention.

### MODE(S) FOR CARRYING OUT THE INVENTION

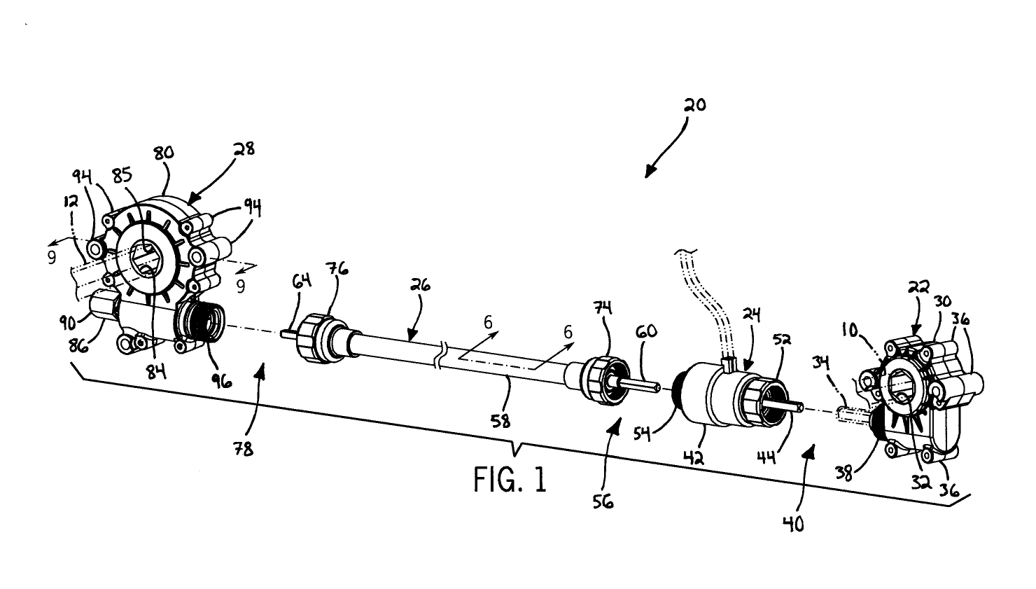

Referring first to FIG. 1, a seed metering device drive system 20 according to the present invention permits easy adjustment of an angular position of the seed metering shaft 12 relative to the drive shaft 10. This in turn permits easy adjustment of the seed offset between rows if two systems 20 define a pair of seeding devices of a twin-row seeding implement.

In general, the seed metering device drive system 20 includes a drive shaft gearbox or transmission 22 that is driven by the drive shaft 10 of a twin-row seeding implement (not shown). The drive shaft transmission 22 drives a clutch assembly 24 that in turn drives a flexible shaft assembly 26. The flexible shaft assembly 26 drives a seed meter gearbox or transmission 28 that in turn drives the seed meter shaft 12 of the associated seed meter (not shown). The following paragraphs further describe these components of the drive system 20 as well as features that facilitate easy adjustment of the seed meter shaft 12 relative to the drive shaft 10.

Still referring to FIG. 1, the drive shaft transmission 22 includes a transmission housing 30 that rotatably supports several internal components that transmit the rotary power of the drive shaft 10. In particular, the transmission housing 30 supports a drive shaft transmission input 32 that connects to and is rotated by the drive shaft 10. In some embodiments and as shown in the figures, the input 32 includes a hexagonal internal passageway that receives the drive shaft 10. Moreover, the input 32 may be a helical gear that engages and drives another helical gear (not shown) within the drive shaft transmission 22.

Regardless of its specific construction, the drive shaft transmission input 32 drives a rotatable drive shaft transmission output coupling 34. In some embodiments, the output coupling 34 may be the helical gear driven by the input 32. Additionally, in some embodiments and as shown in the figures, the output coupling 34 has an internal passageway with a square cross-sectional shape to engage a component of the clutch assembly 24 as described in further detail below. Alternatively, the internal passageway of the output coupling 34 may have a different cross-sectional shape provided that it is capable of engaging the clutch assembly 24.

In addition to the components the transmission housing 30 accommodates as described above, the housing 30 also includes a plurality of mounting features 36 (e.g., flanges having passageways for receiving fasteners) to secure the drive shaft transmission 22 relative to the agricultural implement. The housing 30 also defines a first connecting member 38 of a first connection interface 40 proximate the output coupling 34. In some embodiments and as shown in the figures, the first connecting member 38 is an externally threaded surface. As described in further detail below, the first connecting member 38 connects to the clutch assembly 24.

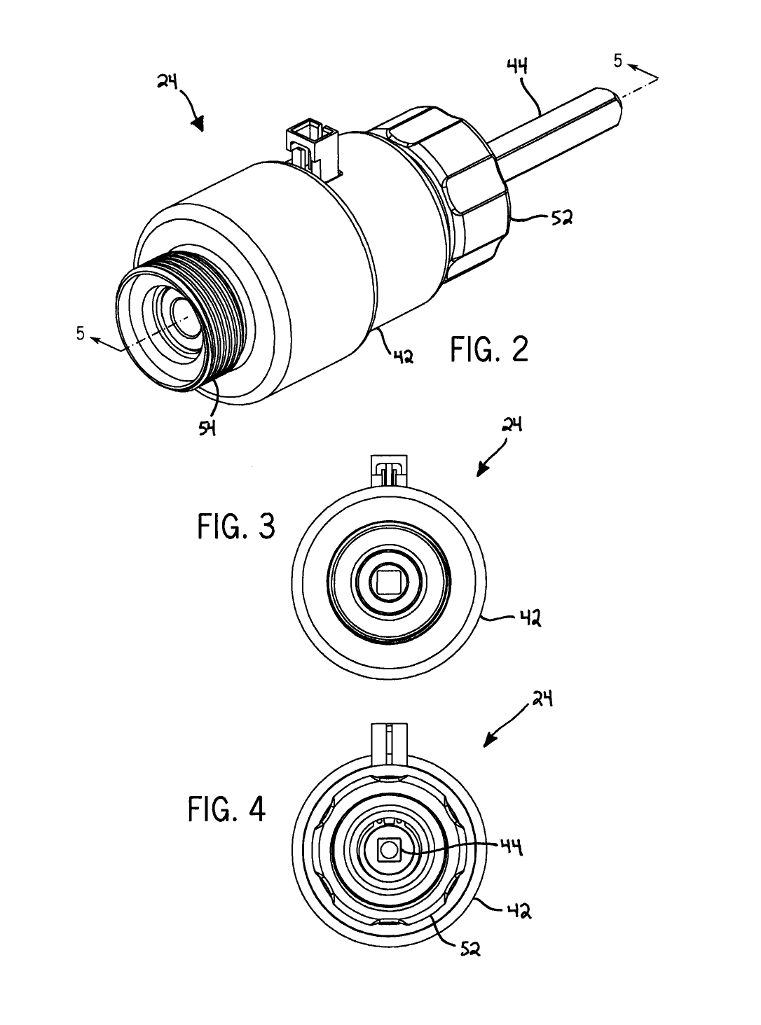

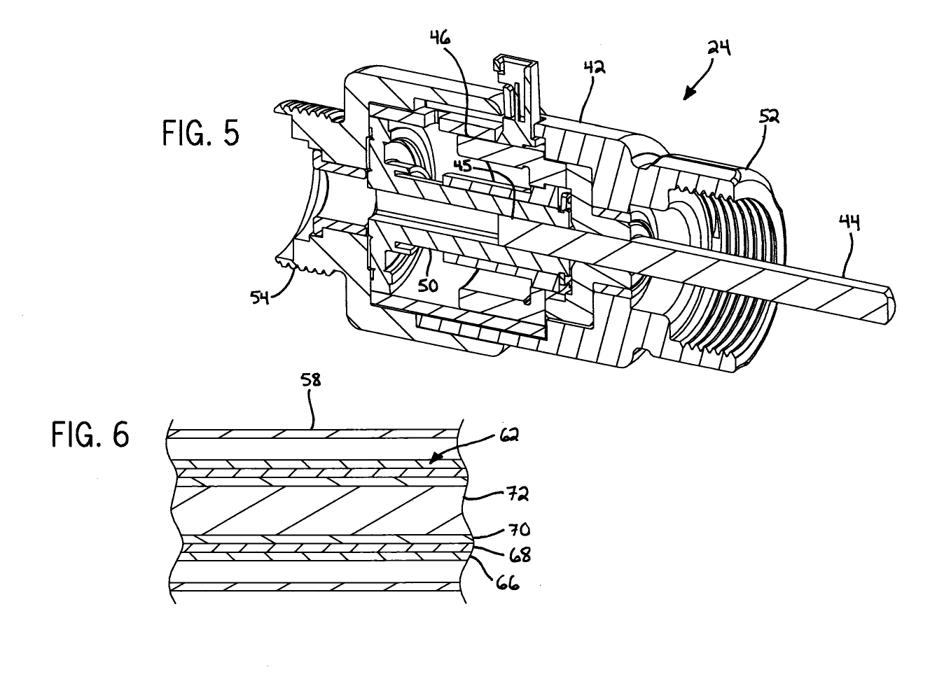

Referring now to FIGS. 1-5 and particularly FIG. 5, the clutch assembly 24 includes a clutch housing 42 that supports several internal power-transmitting components. In particular, the clutch housing 42 supports a rotatable clutch input coupling 44 that connects to and is driven by the drive shaft transmission output coupling 34. In some embodiments and as shown in the figures, the clutch input coupling 44 has a square cross-sectional shape that is received in the internal passageway of the drive shaft transmission output coupling 34. Alternatively, the clutch input coupling 44 may have a different cross-sectional shape that is capable of being received in the internal passageway of the drive shaft transmission output coupling 34 and driven by the drive shaft transmission output coupling 34. As another alternative, the drive shaft transmission output coupling 34 may have a positive shape (e.g., a square cross-sectional shaped shaft) and the clutch input coupling 44 may have the inverse shape (e.g., a square cross-sectional passageway).

The clutch input coupling 44 also serves as the input to a clutch 46. The clutch 46 may be of any appropriate type, such as an electrically-actuated wrap spring clutch or the like, provided that it transmits power from the input coupling 44 to an output coupling 50 if the input coupling 44 is driven in a first direction and rotatably disconnects the input coupling 44 and the output coupling 50 or “free wheels” if the input coupling 44 is driven in a second direction. Furthermore, the clutch 46 may be engaged and disengaged to selectively drive the seed meter shaft 12 via the drive shaft 10.

The clutch 46 connects to and drives or, as shown in the figures, integrally connects to and drives the rotatable clutch output coupling 50. In some embodiments and as shown in the figures, the clutch output coupling 50 has an internal passageway with a square cross-sectional shape to engage a component of the flexible shaft assembly 26. As shown in the figures, the clutch output coupling 50 may receive an end portion 45 of the clutch input coupling 44. However, this portion 45 of the input coupling 44 preferably has a circular cross-sectional shape such that the input coupling 44 selectively drives the output coupling 50 via the clutch 46.

In addition to the internal components described above, the clutch housing 42 also supports a second connecting member 52 of the first connection interface 40. In some embodiments and as shown in the figures, the second connecting member 52 is an integrally mounted swivel nut having an internally threaded surface with the same thread size and pitch as the first connecting member 38. As such, the second connecting member 52 may be rotated in one direction to connect to the first connecting member 38 and thereby secure the clutch assembly 24 to the drive shaft transmission 22. Conversely, the second connecting member 52 may be rotated in the opposite direction to disconnect from the first connecting member 38 and thereby detach the clutch assembly 24 and the drive shaft transmission 22.

At the opposite end from the second connecting member 52, the housing 42 includes a first connecting member 54 of a second connection interface 56. In some embodiments and as shown in the figures, the first connecting member 54 is an externally threaded surface. In any case, the first connecting member 54 connects to the flexible shaft assembly 26 as described in further detail below.

Referring now to FIGS. 1 and 6, the flexible shaft assembly 26 includes a flexible shaft housing 58 that rotatably supports several internal power-transmitting components. In particular, the flexible shaft housing 58 rotatably supports a flexible shaft input coupling 60 that connects to and is driven by the clutch output coupling 50. In some embodiments and as shown in the figures, the flexible shaft input coupling 60 has a square cross-sectional shape that is received in the internal passageway of the clutch output coupling 50. Alternatively, the flexible shaft input coupling 60 may have a different cross-sectional shape that it is capable of being received in the internal passageway of the clutch output coupling 50 and driven by the clutch output coupling 50. As another alternative, the clutch output coupling 50 may have a positive shape (e.g., a square cross-sectional shaped shaft) and the flexible shaft input coupling 60 may have the inverse shape (e.g., a square cross-sectional passageway).

Referring particularly to FIG. 6, the flexible shaft input coupling 60 connects to a flexible core or shaft 62 via, e.g., a crimped connection (not shown). The flexible shaft 62 may be of any appropriate type, such as the flexible shafts produced by Elliott Manufacturing of Binghamton, N.Y. In general, the flexible shaft 62 is a semi-flexible component that transmits power between the drive shaft transmission 22 and the seed meter transmission 28. As used herein, the term “semi-flexible” and variations thereof mean that a component can support a torsional load, but buckles when subjected to axial compressive and side bending loads, and can stretch when subjected to an axial tension load. In addition, such components can significantly change shape without experiencing plastic deformation when first placed in a taut configuration and then subjected to compressive and/or bending loads. Stated another way, a longitudinal axis of the component can extend along one or more significant curves without subjecting the component to plastic deformation, and the component can be bent into a curved shape so as to exert a rotary driving torque about its axis from one end to the other while maintaining the curved shape. Stated yet another way, the semi-flexible structure permits the flexible shaft 62 to rotate while connecting two couplings that are misaligned (i.e., the flexible shaft input coupling 60 and a flexible shaft output coupling 64 connected to the opposite side of the shaft 62).

In some embodiments and as shown in the figures, the flexible shaft 62 comprises several layers of wires 66, 68, and 70 helically wound over a central wire 72 and connected at their ends via, e.g., a welded connection (not shown). The central wire 72 may itself comprise multiple layers of helically wound wires (not shown). Furthermore, two of the layers of wires 66 and 70 may be wound in a first direction and the other layer of wires 68 may be wound in a second direction to permit the flexible shaft 62 to transmit torque if rotated in either direction.

As described briefly above, the flexible shaft 62 connects to a rotatable flexible shaft output coupling 64 opposite the flexible shaft input coupling 60. The flexible shaft 62 may connect to the flexible shaft output coupling 64 via, e.g., a crimped connection (not shown). In some embodiments and as shown in the figures, the flexible shaft output coupling 64 has a square cross-sectional shape that is generally identical to the shape of the flexible shaft input coupling 60.

In addition to the internal components described above, the shaft housing 58 also supports a second connecting member 74 of the second connection interface 56. In some embodiments and as shown in the figures, the second connecting member 74 is a rotatably mounted swivel nut having an internally threaded surface with the same thread size and pitch as the first connecting member 54 of the second connection interface 56. As such, the second connecting member 74 may be rotated relative to the shaft housing 58 in one direction to connect to the first connecting member 54 and thereby secure the flexible shaft assembly 26 to the clutch assembly 24. Conversely, the second connecting member 74 may be rotated relative to the shaft housing 58 in the opposite direction to disconnect from the first connecting member 54 and thereby detach the flexible shaft assembly 26 and the clutch assembly 24.

At the opposite end, the flexible shaft housing 58 supports a first connecting member 76 of a third connection interface 78. In some embodiments and as shown in the figures, the first connecting member 76 is a rotatably mounted swivel nut having an internally threaded surface with the same thread size and pitch as the second connecting member 74 of the second connection interface 56.

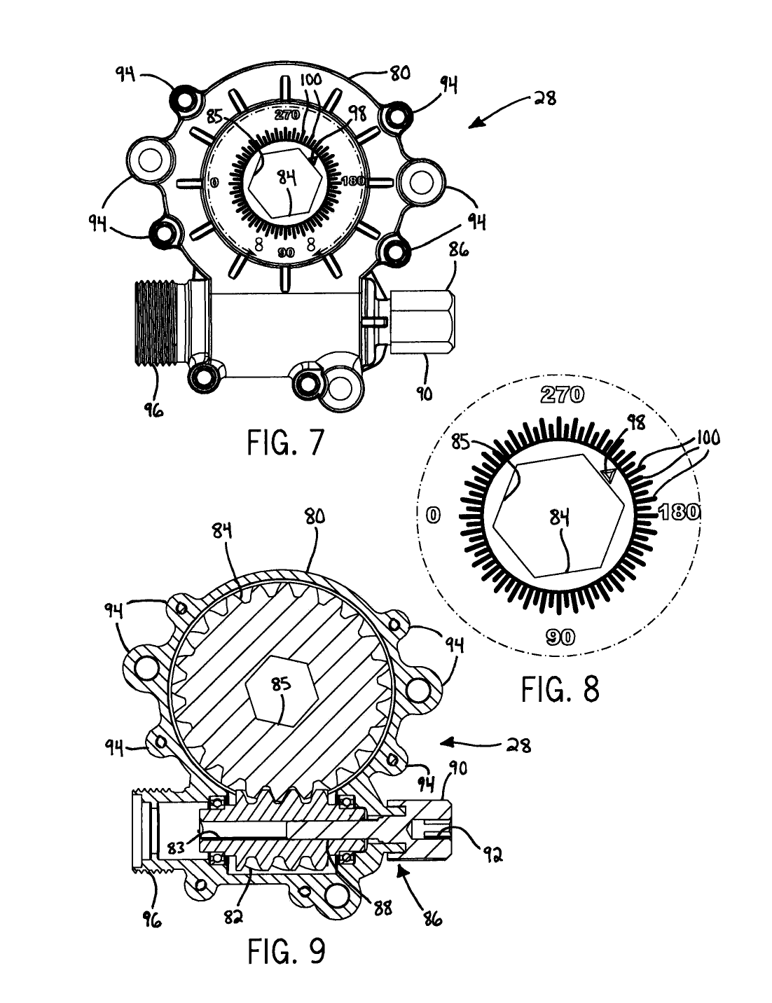

Referring now to FIGS. 1 and 7-9, the seed meter transmission 28 includes a transmission housing 80 that rotatably supports several internal components that transmit the rotary power received from the flexible shaft assembly 26. In particular, the transmission housing 80 includes a rotatable seed meter transmission input 82 (FIG. 9). In some embodiments and as shown in the figures, the input 82 has internal walls that define a square-cross sectional passageway 83 to receive and engage the flexible shaft output coupling 64. Alternatively, the input 82 may have a passageway 83 with a different shape that it is capable of drivingly receiving the flexible shaft output coupling 64. As another alternative, the input 82 may have a positive shape (e.g., a square cross-sectional shaped shaft) and the flexible shaft output coupling 64 may have the inverse shape (e.g., a square cross-sectional passageway).

As shown in the figures, in some embodiments the input 82 is a helical gear that drives a perpendicularly-rotating output helical gear 84 within the seed meter transmission 28. The output 84 includes a hexagonal internal passageway 85 that receives and drivingly engages the seed meter shaft 12.

The input 82 also connects to and engages an adjustment element 86 disposed on the opposite side of the input 82 from the flexible shaft output coupling 64. The adjustment element 86 includes features that permit adjustment of the angular position of the seed meter shaft 12 relative to the drive shaft 10. In particular, the adjustment element 86 includes a square section 88 (FIG. 9) that is received and engaged in the passageway 83 of the input 82. Alternatively, the section 88 may have a different shape provided that it is capable of being driven by the input 82. As another alternative, the section 88 may have a negative shape (e.g., a square cross-sectional passageway) and the input 82 may have a positive shape (e.g., a square cross-sectional shaped shaft). In any case, the adjustment element 86 rotates together with the input 82.

The square section 88 connects to an external section 90 of the adjustment element 86 that, as the name implies, extends through and is disposed outside of the transmission housing 80. In some embodiments, the external section 90 may have a hexagonal shape to engage a box end wrench, a socket wrench, or the like. Furthermore, the external section 90 may have an internal square passageway 92 to receive a tool with a square shape.

Regardless of the type of tool used, the adjustment element 86 is manually rotatable by an operator to drive the input 82, the output 84, and the seed meter shaft 12. The operator may rotate the adjustment element 86 in the first direction (i.e., the same direction it is driven by the drive shaft 12) because such an action causes the clutch assembly 24 to free wheel. As such, the drive shaft 10 does not rotate as the adjustment element 86 is manually rotated in the first direction and the seed meter shaft 12 rotates. The seed offset between adjacent seed metering devices may thereby be easily adjusted.

In addition to the components the transmission housing 80 accommodates as described above, the housing 80 also includes a plurality of mounting features 94 (e.g., flanges having passageways for receiving fasteners) to secure the seed meter transmission 28 relative to the agricultural implement. The housing 80 also defines a second connecting member 96 of the third connection interface 78 proximate the input 82. In some embodiments and as shown in the figures, the second connecting member 96 is an externally threaded surface having the same thread size and pitch as the first connecting member 76. In any case, the second connecting member 96 matingly engages the first connecting member 76 of the third connection interface 78.

To indicate the angular position of the seed meter shaft 12 and permit comparisons between adjacent seed metering devices, the output 84 may include an angular marker 98 (e.g., an arrow) that points to one of a plurality of angular indicators 100 disposed on the transmission housing 80 and surrounding the shaft 12. The indicators 100 may be straight lines offset from each other by equal angles (e.g., five degrees). Furthermore, adjacent indicators may have different lengths (e.g., indicators at angles of 10n degrees, where n is a non-negative integer from zero to thirty-five, may be relatively long and angles of 10n+5 degrees may be relatively short). Further still, some angles may also include their numerical value (e.g., angles of 90m degrees, where m is a non-negative integer from zero to three).

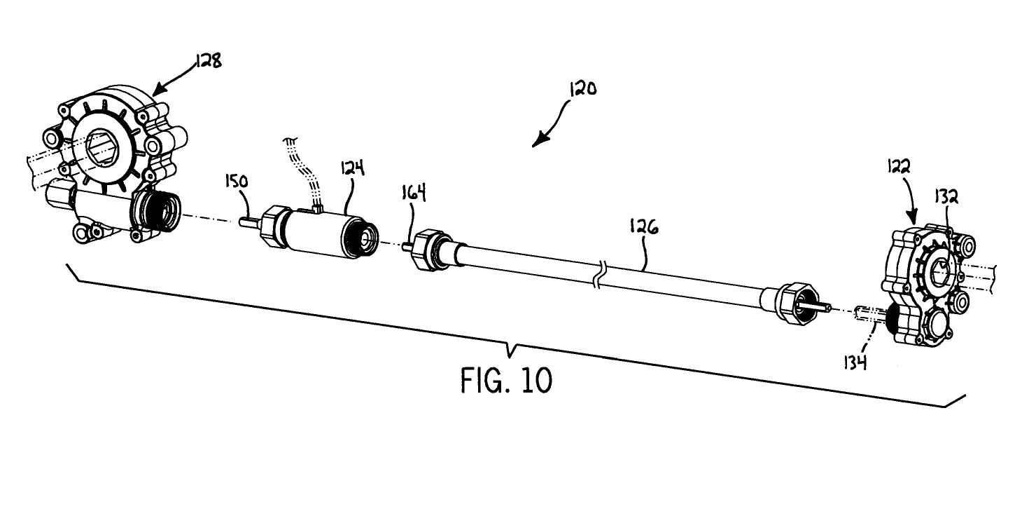

Turning now to FIG. 10, a second embodiment of a seed metering device drive system 120 according to the present invention will briefly be described. The seed metering device drive system 120 is generally similar to the system 20 shown in FIGS. 1-9 and advantageously includes a seed meter transmission 128 as described above. However, the second embodiment of the system 120 has several structural differences from the first embodiment. First, the drive shaft transmission 122 is a parallel-shaft helical gear transmission; that is, the input and output couplings 132 and 134 are helical gears having parallel axes of rotation. Second, the flexible shaft assembly 126 may be larger than that of the first embodiment of the system 20 to transmit larger torques. Finally, the clutch assembly 124 connects to the opposite end of the flexible shaft assembly 126 compared to the first embodiment of the system 20. In particular, the clutch assembly 124 connects the flexible shaft assembly 126 to the seed meter transmission 128. To this end, the clutch input coupling (not shown) receives the flexible shaft output coupling 164, and the clutch output coupling 150 is received in the seed meter transmission input.

From the above description, it should be apparent that the present invention provides a seed meter drive system that permits easy adjustment of the angular position of the seed meter shaft relative to the drive shaft, which thereby permits easy adjustment of the seed offset between adjacent seed metering devices. As described above, such an adjustment may easily be achieved by manually turning the adjustment element with an appropriate tool.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

1. An apparatus for transmitting power from a drive shaft to a seed meter shaft of a seed metering device, comprising:
a transmission including:
a transmission housing;
an input rotatably supported by the transmission housing and having a first end configured to engage by a coupling driven by the drive shaft such that the coupling drivingly engages the input, the input also having a second end opposite the first end;
an output rotatably supported by the transmission housing, the output being directly driven by the input and configured to drive the seed meter shaft; and
an adjustment element rotatably supported by the housing and drivingly connected to the second end of the input, the adjustment element being manually rotatable to rotate the input and the output and thereby adjust an angular position of the seed meter shaft relative to the drive shaft.

2. The apparatus of claim 1, further comprising a clutch assembly connecting the drive shaft to the input, the adjustment element being manually rotatable only in a first direction to adjust the angular position of the seed meter shaft relative to the drive shaft as the clutch assembly free wheels and rotatably disconnects the drive shaft and the seed meter shaft.

3. The apparatus of claim 2, wherein the clutch assembly is a wrap spring clutch assembly.

4. The apparatus of claim 1, wherein the output includes an angular marker, the transmission housing includes a plurality of angular indicators surrounding the angular marker, and the angular marker aligns with angular indicators as the output rotates to indicate the angular position of the seed meter.

5. The apparatus of claim 4, wherein the output includes a passageway configured to engage the seed meter shaft, the angular marker being disposed adjacent the passageway.

6. The apparatus of claim 1, wherein the input and the output are helical gears.

7. The apparatus of claim 6, wherein the input gear and the output gear are perpendicular helical gears.

8. The apparatus of claim 1, wherein the input includes a passageway receiving the coupling and the adjustment element, the coupling extends from the passageway on the first end of the input, and the adjustment element extends from the passageway on the second end of the input.

9. The apparatus of claim 8, wherein the adjustment element includes a manually rotatable external section disposed outside the transmission housing.

10. The apparatus of claim 8, wherein the input includes a wall defining a square cross-sectional shape of the passageway, and the adjustment element includes a square section received in the passageway and engaging the wall.

11. The apparatus of claim 10, wherein the adjustment element further includes a hexagonal-shaped section connected to the square section and disposed outside of the transmission housing.

12. The apparatus of claim 11, wherein the hexagonal-shaped section of the adjustment element defines an internal square passageway.

13. An apparatus for transmitting power from a drive shaft to a seed meter shaft of a seed metering device, comprising:
a wrap spring clutch assembly driven by the drive shaft, the clutch assembly transmitting power from an input to an output if the input is driven in a first direction and rotatably disconnecting the input and the output if the input is driven in a second direction;
a coupling driven by the wrap spring clutch assembly;
a transmission including:
a transmission housing;
an input gear rotatably supported by the transmission housing and driven by the coupling;
an output gear rotatably supported by the transmission housing and driven by the input gear, the output gear being configured to drive the seed meter shaft; and
an adjustment element rotatably supported by the housing and connected to the input gear, the adjustment element being manually rotatable only in the first direction to rotate the input gear and the output gear to thereby adjust an angular position of the seed meter shaft relative to the drive shaft as the wrap spring clutch assembly rotatably disconnects the input and the output.

14. The apparatus of claim 13, wherein the input gear includes a wall defining a square cross-sectional shaped passageway, the coupling includes a square section received in the passageway and engaging the wall.

15. The apparatus of claim 13, wherein the wrap spring clutch assembly is an electrically actuated wrap spring clutch assembly.

16. The apparatus of claim 13, wherein the output gear includes an angular marker, the transmission housing includes a plurality of angular indicators surrounding the angular marker, and the angular marker aligns with angular indicators as the output gear rotates to indicate the angular position of the seed meter.

17. The apparatus of claim 16, wherein the output gear includes a passageway configured to engage the seed meter shaft, the angular marker being disposed adjacent the passageway.

18. The apparatus of claim 13, wherein the input gear includes a passageway receiving the adjustment element, and the adjustment element extends from the passageway and includes a manually rotatable external section disposed outside the transmission housing.

19. The apparatus of claim 18, wherein the manually rotatable external section is a hexagonal-shaped section.

20. The apparatus of claim 13, wherein the input gear and the output gear are perpendicular helical gears.

21. The apparatus of claim 1, wherein the drive shaft is directly connected to the first end of the input, and wherein the adjustment element is directly connected to the second end of the input.

22. The apparatus of claim 1, wherein the drive shaft, the input and the adjustment element are connected to be rotatable in the same direction simultaneously.

23. The apparatus of claim 1, wherein the angular position of the seed meter shaft relative to the drive shaft is adjustable by any amount.

24. The apparatus of claim 3, wherein the wrap spring clutch assembly is an electrically actuated wrap spring clutch assembly.

25. The apparatus of claim 13, wherein the output is directly driven by the input.

26. The apparatus of claim 13, wherein the drive shaft is directly connected to the first end of the input, and wherein the adjustment element is directly connected to the second end of the input.

27. The apparatus of claim 13, wherein the drive shaft, the input and the adjustment element are connected to be rotatable in the same direction simultaneously.

28. The apparatus of claim 13, wherein the angular position of the seed meter shaft relative to the drive shaft is adjustable by any amount.
